(19) United States
(12) Patent Application Publication
(10) Pub. No.: US 2005/0252243 A1
(43) Pub. Date: Nov. 17, 2005

(54) Method and arrangement for feeding a glass melt to a processing process

(75) Inventors: Christian Kunert, Mainz (DE); Andreas Langsdorf, Ingelheim (DE); Frank Thomas Lentes, Bingen (DE); Klaus Dieter Duch, Taunusstein (DE); Andre Thess, Dresden (DE); Yurll Kolesnikov, Riga (LV)

Correspondence Address: Charles N. J. Ruggiero, Esq.;Ohlandt, Greeley, Ruggiero & Perle, L.L.P., One Landmark Square, 10th floor, Stamford, CT, 06901-2682, US

(73) Assignee: Schott AG

(21) Appl. No.: 11/087,431

(22) Filed: Mar. 23, 2005

(30) Foreign Application Priority Data
Mar. 25, 2004 (DE) 102004015055.9-45

(51) Int. Cl. C03B 7/00

(52) U.S. Cl. 65/122; 65/324

(57) ABSTRACT

The invention includes a method and an arrangement for influencing the flow of glass melts in a controlled way during the transfer from the melting furnace to a processing process. The simultaneous generation of electric and magnetic fields generates a force in the glass melt which boosts or inhibits the melt flow and acts substantially in the same direction as or in the opposite direction to the main direction of flow. It is in this way possible to control the melt flow without affecting the temperature of the melt. Consequently, the invention is suitable in particular for the accurately controllable feeding of a homogeneous glass melt to a glass production process.

The invention includes a method and an arrangement for influencing the flow of glass melts in a controlled way during transfer from the melting furnace to a processing process, and is suitable in particular for the accurately controllable feeding of a homogeneous glass melt to a glass production process.

### DESCRIPTION

The melt flow of glass melts which are to be discharged from melting furnaces is still in many instances controlled mechanically by changing the cross section of the passages carrying glass melt by means of needles, level means or stopper rods which can completely or partially close an opening. To ensure a melt flow that is as uniform as possible, the control has to be adapted to the current melt flow, which is subject to a large number of influencing variables.

However, the mechanical control means are only relatively imprecise, since at the high temperatures of the glass melts the components for regulating the throughflow are subject to considerable structural tolerances and it is impossible or difficult to react to fluctuations in viscosity which occur, for example, as a result of chemical inhomogeneities or temperature changes.

One further option for flow control is to influence the viscosity of the glass melt by means of changes in the temperature of the glass melt in the passage carrying glass melt. In particular direct and indirect electrical heating means, as described, for example, in DE 24 61 700 C3, DE 35 28 332 A1 or U.S. Pat. No. 5,599,182, have proved particularly suitable for this purpose.

However, these flow control means are still very imprecise and have an effect on the thermal homogeneity of the glass melt, since they generally only influence the layer of the melt which is in direct contact with the passage wall. The altered temperature or temperature distribution in the glass melt affects the shaping processes which generally follow immediately afterward and can often only be operated within very narrow temperature windows, and therefore also affects the quality of the glass products. By way of example, changes in the temperature of the glass supplied lead to fluctuations in the geometry of the product produced by drawing processes, such as tube and flat glass drawing.

Moreover, an increase in the temperature in the passage carrying glass melt in order to increase the throughflow rate can lead to the formation of bubbles, which cause production scrap. A further drawback is that the glass melt only reacts very slowly to a change in the heating power, on account of its low thermal conductivity.

However, a flow rate which is very constant over the course of time and provides very homogeneous glass melts is necessary for the production of glass gobs which are accurately portioned in terms of their mass and of highly accurate glasses of a high quality. The portioning of the glass gobs is generally under time control, and the more constantly the flow out of a melting unit can be regulated, the more accurately this portioning can be set. Fluctuations in viscosity or glass temperature make this constancy over the course of time very difficult to achieve. Moreover, control interventions by means of the temperature can lead to the formation of streaks in the glass, for example, which is impermissible for glasses used for optical purposes.

Therefore, it is an object of the invention to allow very accurate control of the flow of glass melts when they are being fed to a glass production process without the thermal and/or chemical homogeneity of the glass melts being adversely affected.

The object is achieved by a method as described in claim 1 and an apparatus as described in claim 13.

According to the invention, the glass melt is fed from the melting furnace through a passage to a processing process, with the quantitative melt flow being controlled by means of electromagnetic forces, known as Lorentz forces. The Lorentz forces are generated by a combination of electric and magnetic fields. This requires at least the simultaneous generation of an electric field and a magnetic field superimposed on it in at least one portion of the passage carrying glass melt. Suitable arrangement of the direction of the fields results in forces which act on the ions that are present in the melt and which, as seen cumulatively over the passage cross section, boost or inhibit the melt flow through the passage. The field strengths of the electric fields are between 1 and 20 000 V/m, preferably between 50 and 3000 V/m, and those of the magnetic fields are between 1 and 25 000 mT, preferably between 20 and 2000 mT.

The fields are designed in such a way that the forces which act on the glass melt lead only to an acceleration or deceleration of the glass melt, while maintaining the original direction of flow. In particular, reversal of the direction of flow in parts of the cross section of the passage carrying glass is avoided, since this can lead to instabilities in the process.

The result is very accurate control of the flow of glass melts, which allows the flow to be influenced without any detrimental effect on the thermal and chemical homogeneity of the glass melt.

This positive effect is boosted further if the power of the current used to generate the electric field is selected in such a way as to provide a heating power which compensates for the heat losses occurring in the passage.

The control of the melt flow according to the invention may preferably be implemented in combination with conventional control means, preferably following conventional control of this type, for example by imprecise setting of the flow in the passage by level means and/or heating of the melt flow and subsequent accurate setting by the control using electric and magnetic fields.

This accurate control can advantageously be effected by changing the field strength of the magnetic field, so that it is possible to vary the accelerating or inhibiting force acting on the melt. Therefore, fluctuations in throughput can be compensated for very accurately without changing the temperature and in particular the temperature homogeneity of the melt.

To generate the volumetric force in the melt, it is necessary for the electric and magnetic fields to enclose an angle with respect to one another, which angle amounts to greater than 0° and less than or equal to 90°. The angle between the fields and the direction of flow of the melt must be within the same limits. To influence the glass melt particularly effectively, the electric field and the magnetic field are preferably oriented perpendicular to one another and perpendicular to the direction of flow of the glass melt, i.e. perpendicular to the passage axis.

To avoid electrolysis of the glass melt, the control of the melt flow is preferably effected by synchronous electric and magnetic alternating fields, the direction of which alternates at frequencies of between 1 Hz and 15 kHz, preferably between 45 and 65 Hz.

It is also possible to use pulsed electric and/or magnetic fields. The pulse lengths and pauses between the pulses are in this case to be set in such a way that a substantially constant decelerating or accelerating effect is nevertheless set on the melt, on account of the inertia of the melt. In particular, the pauses between the pulses should last no longer than 10 s.

To control the forces acting on the melt and therefore to influence the melt flow, it is advantageous to vary the phase position between the electric field and the magnetic field. In particular, it is possible to set the phase position of the alternating fields in such a way with respect to one another that the accelerating or decelerating force acting on the melt is maximized for given field strengths.

The cross section of the passage carrying glass melt can be selected as desired, but this passage is generally round, elliptical or rectangular in cross section.

To control the glass melt, it is sufficient for the electric and magnetic fields to have a field strength distribution which is homogeneous over the cross section of the passage carrying glass melt. However, it is preferable to generate inhomogeneous fields which, for example, generate stronger force in the center of the passage than in the boundary zones, so that a hot central flow in the passage can be effectively decelerated.

The magnetic field is preferably generated using magnets, in particular electromagnets, arranged outside the passage, by which means it is possible to vary the strength and direction of the magnetic field in a very simple way by means of the strength and phase of the applied electric currents.

Another possible way of generating the magnetic field is to use permanent magnets which are arranged outside the passage carrying melt. These magnets have the advantage that, unlike in the case of electromagnets, there are no costs for ongoing operation. Moreover, high magnetic field strengths are commercially available at a relatively favorable rate when using permanent magnets.

Magnetic alternating fields can also be generated using permanent magnets within the melt by suitable movement of the permanent magnets, e.g. a rotary movement around the passage carrying melt.

In one embodiment of the invention, the electrodes which are required to generate the electric field are arranged inside the passage, at a required distance from the passage walls, and may, for example, be designed as rod or plate electrodes. In this case, the passage walls may consist of electrically conductive material, for example of precious metal, preferably platinum, alloys.

However, it is preferable for the electrodes to be designed as part of the passage walls. In this case, the remainder of the passage walls consists of material which is electrically nonconductive or has only a poor electrical conductivity, preferably of refractory ceramic (for example of zirconium oxide, zirconium silicate, aluminum oxide).

However, it is also possible for the electrodes to be arranged outside the passage, if the latter consists of a material which does not significantly attenuate the electric field. Examples of materials of this type include refractory ceramics.

When using the controlled feeding in accordance with the invention of the glass melt to a processing process, the control of the melt flow by means of the electric and magnetic fields may, of course, be effected as either open-loop or closed-loop control.

In addition to keeping the melt flow constant, it is also possible to make the throughput cyclical or variable, in particular on a periodic basis.

The method according to the invention and the apparatus according to the invention are suitable for all processes which require a very constant feed of a glass melt to a processing process. By way of example, a mass flow from a nozzle which is very constant over the course of time is important for the production of accurately portioned glass gobs for lens production. The same is true of processes for updraw and downdraw methods for producing flat glass, in particular for electronics and display applications. A very constant incoming flow of glass melt is also required for the continuous production of highly accurate glass tubes and is not hitherto possible using the conventional methods. Further applications are also conceivable.

The invention is explained in more detail below on the basis of the drawings and an exemplary embodiment, without being restricted to these embodiments. In the drawings:

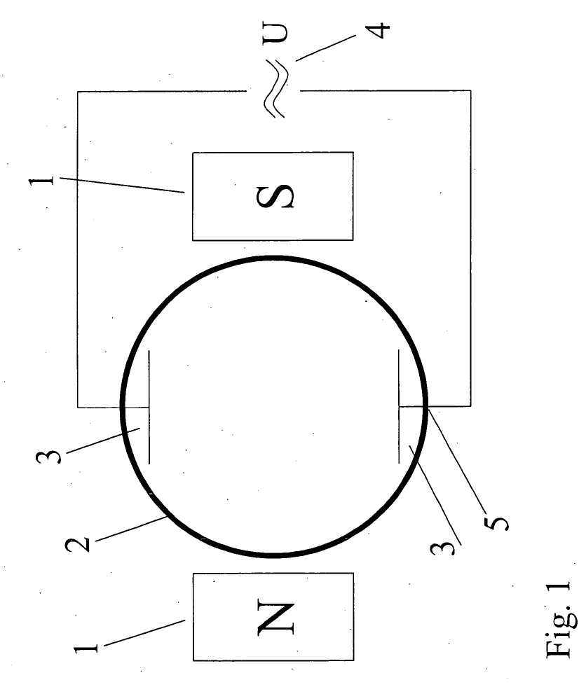

FIG. 1 shows a diagrammatic illustration with a round passage cross section and electrodes inside the passage,

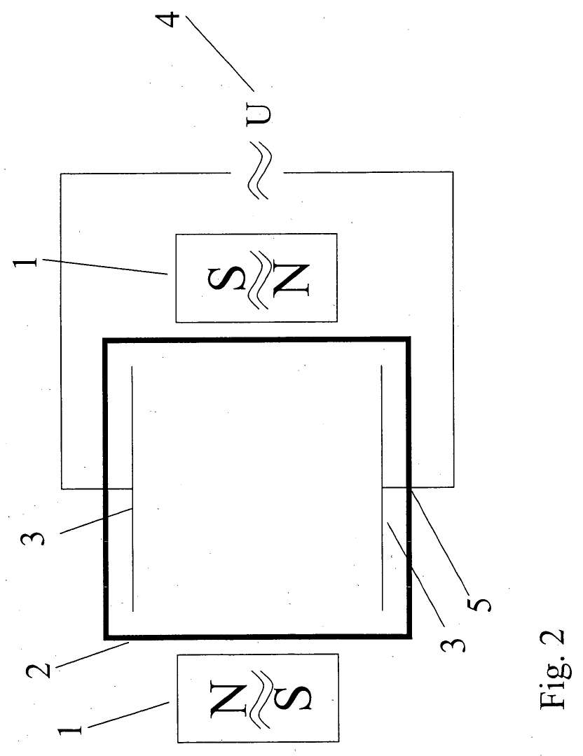

FIG. 2 shows a diagrammatic illustration with a rectangular passage cross section and electrodes inside the passage,

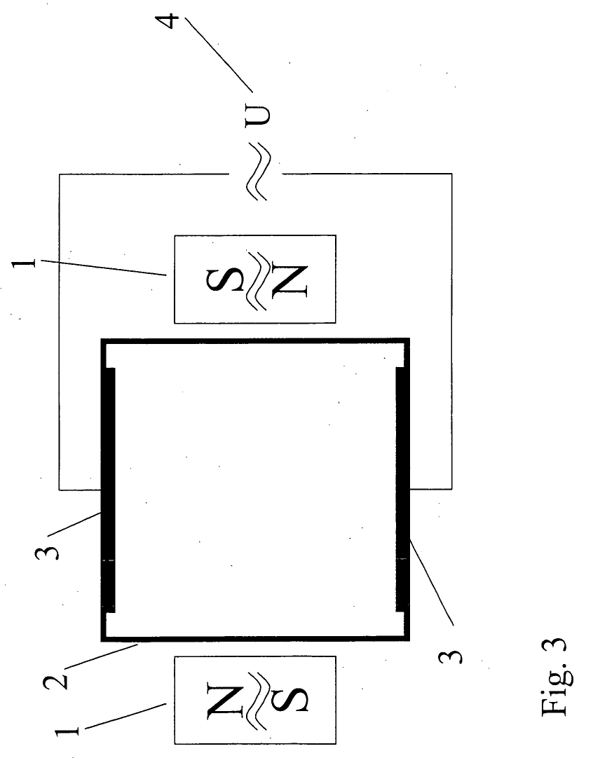

FIG. 3 shows a diagrammatic illustration with a rectangular passage cross section and electrodes forming part of the walls of the passage,

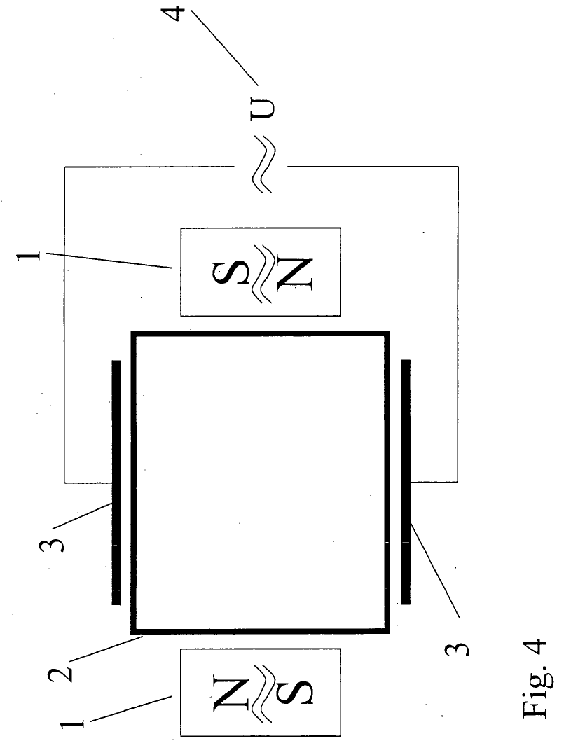

FIG. 4 shows a diagrammatic illustration with a rectangular passage cross section and electrodes outside the passage.

FIGS. 1 to 4 show diagrammatic illustrations of possible cross sections of a passage (2) carrying glass melt, with poles of magnets (1) arranged outside the passage (2), as well as possible arrangements for the electrodes (3), which are fed with AC voltage by a voltage supply (4).

The poles of the magnets (1) preferably have an alternating polarity. If the electrodes (3) are formed inside the passage (2), as illustrated in FIGS. 1 and 2, the passage (2) must have leadthroughs (5), in the case of conductive passage walls electrically insulated leadthroughs (5).

According to one exemplary embodiment of the invention, a vertical cylindrical passage is employed, as is used, for example, in the production of optical glass. On account of the small melting units used in processes of this type, relatively minor fluctuations are often retained without any reduction in magnitude all the way through to shaping, which means that it is necessary to accurately compensate for any such faults.

In a segment of the passage designed as shown in FIG. 1, with a diameter of 50 mm and a length of 300 mm, to compensate, for example, for a fluctuation in the melt flow of up to approx. 8%, an electric field with a frequency of 50 Hz and a field strength of 200 V/m for an electric conductivity of the glass melt of 10 (Ωmm)⁻¹ and a magnetic field with a field strength of 1 Tesla and the same frequency are generated at the same time.

The effect of these fields is to produce volumetric forces of approximately 2000 N/m³ in the passage, either in the direction of flow of the glass or in the opposite direction to the direction of flow of the glass, depending on the orientation of the fields with respect to one another.

Compared to the force of gravity, which in the case of a glass melt corresponds to a volumetric force of approximately 25 000 N/m³, it will be recognized that it is possible to reduce or increase the flow through this passage segment by 8% of the throughflow which takes place under the free action of the force of gravity. This range is sufficient to compensate for the fluctuations caused by other process steps.

This effect can be boosted still further by further measures for influencing the flow in the upstream or downstream direction.

In further embodiments, it is also possible for a passage to be arranged horizontally, as is customary, for example, when producing flat glass. The thickness of the glass ribbon produced is dependent, inter alia, on the temperature and mass throughput of the glass melt which is fed in. The fluctuations in the thickness of the glass can be reduced considerably by reducing the fluctuations in throughput when supplying the glass melt without altering the temperature.

1. A method for feeding a glass melt to a processing process, comprising:
feeding the glass melt to the processing process from a melting furnace through a passage; and
controlling a flow of the glass melt within the passage, the controlling comprising simultaneously generating at least one electric field and at least one magnetic field in at least one portion of the passage to generate a force that accelerates or decelerates the flow in a direction of the flow or in an opposite direction to the direction of the flow.

2. The method as claimed in claim 1, wherein the at least one electric field and the at least one magnetic field are generated at an angle with respect to one another that is greater than 0° but less than or equal to 90°,and wherein each of the at least one electric field and the at least one magnetic field is generated at an angle with respect to the direction of the flow that is greater than 0° but less than or equal to 90°.

3. The method as claimed in claim 2, wherein the at least one electric field and the at least one magnetic field are perpendicular to one another, and wherein the at least one electric field and the at least one magnetic field are perpendicular to the direction of the flow.

4. The method as claimed in claim 1, wherein the at least one electric field comprises electric alternating fields and/or the at least one magnetic field comprises magnetic alternating fields.

5. The method as claimed in claim 1, wherein generating the at least one electric field and the at least one magnetic field comprises generating synchronous electric alternating fields and magnetic alternating fields.

6. The method as claimed in claim 4, wherein the electric alternating fields and/or the magnetic alternating fields have frequencies between 1 hertz and 15 kilohertz.

7. The method as claimed in claim 1, wherein the at least one electric field comprises electric alternating fields and the at least one magnetic field comprises magnetic alternating fields, wherein the force has resultant volumetric forces acting on the glass melt, the resultant volumetric forces being controlled by varying a phase position between the electric alternating fields and the magnetic alternating fields.

8. The method as claimed in claim 1, wherein the at least one electric field and/or the at least one magnetic field have a field strength distribution that is homogeneous over a cross section of the passage.

9. The method as claimed in claim 1, wherein the at least one electric field and/or the at least one magnetic field have a field strength distribution that is inhomogeneous over a cross section of the passage.

10. The method as claimed in claim 1, wherein the controlling further comprises mechanically controlling the flow.

11. The method as claimed in claim 1, wherein the controlling further comprises heating the glass melt.

12. The method as claimed in claim 1, wherein the controlling further comprises compensating for heat losses from the flow that occur in the passage by a heating power of a current being used to generate the at least one electric field.

13. An apparatus for feeding a glass melt to a processing process, comprising:
a passage that feeds the glass melt from a melting furnace to the processing process; and
a device for controlling a melt flow of the glass flow through the passage, wherein the device simultaneously generates an electric field and a magnetic field in at least one portion of the passage carrying the glass melt, wherein the electric field and the magnetic field simultaneously generate a resultant force that either accelerates or decelerates the melt flow and acts on the melt flow in a direction of flow or in an opposite direction to the direction of flow.

14. The apparatus as claimed in claim 13, wherein the electric field and magnetic field are arranged at an angle with respect to one another that is greater than 0° but less than or equal to 90°, and wherein each of the electric field and the magnetic field is arranged at an angle with respect to the direction of flow that is greater than 0° but less than or equal to 90°.

15. The apparatus as claimed in claim 14, wherein the electric field and magnetic fields are positioned perpendicular to one another, and wherein each of the electric field and the magnetic field is perpendicular to the direction of flow.

16. The apparatus as claimed in claim 13, wherein the device generates alternating fields.

17. The apparatus as claimed in claim 13, wherein the device generates synchronous alternating fields.

18. The apparatus as claimed in claim 16, wherein the device comprises a setter for setting a phase position of the alternating fields.

19. The apparatus as claimed in claim 13, wherein the electric field and/or the magnetic field have a field strength distribution that is homogeneous over a cross section of the passage.

20. The apparatus as claimed in claim 13, wherein the electric field and/or the magnetic field have a field strength distribution that is inhomogeneous over a cross section of the passage.

21. The apparatus as claimed in claim 13, wherein the passage has an elliptical cross section.

22. The apparatus as claimed in claim 13, wherein the passage has a rectangular cross section.

23. The apparatus as claimed in claim 13, wherein the device comprises a plurality of magnets arranged outside the passage.

24. The apparatus as claimed in claim 23, wherein the plurality of magnets are a plurality of electromagnets.

25. The apparatus as claimed in claim 23, wherein the plurality of magnets are a plurality of permanent magnets.

26. The apparatus as claimed in claim 13, wherein the device comprises electrodes arranged inside the passage.

27. The apparatus as claimed in claim 26, wherein the electrodes are rod electrodes or plate electrodes arranged at a distance from the walls of the passage.

28. The apparatus as claimed in claim 13, wherein the device comprises electrodes integral to walls of the passage.

29. The apparatus as claimed in claim 13, wherein the apparatus is usable in the production of optical glass, flat glass or glass tubes.
